(19) United States
(12) Patent Application Publication
(10) Pub. No.: US 2026/0200342 A1
(43) Pub. Date: Jul. 16, 2026

(54) CONTROL SYSTEM FOR VEHICLE

(71) Applicant: TOYOTA JIDOSHA KABUSHIKI KAISHA, Toyota-shi (JP)

(72) Inventors: Kazuma AOKI, Toyota-shi (JP); Takeshi Kitahata, Toyota-shi (JP); Noritaka Takuda, Okazaki-shi (JP); Hiroto Amada, Nagakute-shi (JP); Tatsuya Kawamura, Nagoya-shi (JP); Takeshi Ishiwada, Anjo-shi (JP)

(73) Assignee: TOYOTA JIDOSHA KABUSHIKI KAISHA, Toyota-shi (JP)

(21) Appl. No.: 19/434,960

(22) Filed: Dec. 29, 2025

(30) Foreign Application Priority Data
Jan. 10, 2025 (JP) 2025-004362

(51) Int. Cl. B60L 15/20

(52) U.S. Cl. CPC B60L 15/2054; B60L 2240/423; B60L 2240/48; B60L 2240/642; B60L 2250/24

(57) ABSTRACT

A control system for a vehicle configured to suppress vibrations and shocks when releasing a parking lock mechanism in a situation where a drive shaft is twisted. The control system is configured to: control the motor to start generation of a torque counteracting an estimated torsional torque acting on the driver shaft whose magnitude is equal to the estimated torsional torque or smaller, when the rotary member being locked by the parking lock mechanism is predicted to be released; and terminate the torque generation by the motor when the motor generating the torque starts rotating.

### CROSS-REFERENCE TO RELATED APPLICATIONS

The present disclosure claims the benefit of Japanese Patent Application No. 2025-004362 filed on January 10, 2025 with the Japanese Patent Office, the entire contents of which are hereby incorporated by reference.

### BACKGROUND

### Technical Field

The embodiment of the present disclosure relates to the art of a control system for a vehicle in which a drive shaft is selectively locked by a parking lock mechanism.

### Discussion of the Related Art

In the prior art, there has been known control systems for a vehicle having a parking lock mechanism, in which a rotation of a drive shaft connected to a wheel is stopped by engaging a parking pawl with a parking gear interlocked with the wheel, and in which the drive shaft is allowed to rotate by disengaging the parking pawl from the parking gear.

For example, JP-B-3454009 discloses a parking lock device in which a shift lever operated by a driver and a parking pawl are mechanically connected to each other, and a control apparatus thereof. In the parking lock device described in JP-B-3454009, a large operating force is required to operate a shift lever to disengage the parking pawl from the parking gear, if a load acting on a meshing surface between the parking gear and the parking pawl is large. Therefore, the control apparatus described in JP-B-3454009 is configured to generate torque by the motor in a direction to reduce a meshing load between the parking lock gear and the parking pawl. Specifically, the control apparatus reduces the meshing load between the parking lock gear and the parking pawl by gradually increasing the output torque of the motor and maintaining the torque at a point when a rotational angle of the motor is changed. In addition, the control device is further configured to reduce the output torque of the motor toward "0" when it is determined that the parking lock mechanism is released.

JP-A-2020-100312 discloses a control device applied to a vehicle having a parking lock mechanism, a foot brake device that is actuated when a brake pedal is depressed by a driver to apply a braking force to a wheel, and an electric parking brake that is actuated in conjunction with the parking lock mechanism to continuously apply a braking force to the wheel. The control device described in JP-A-2020-100312 is configured to apply the braking force continuously to the wheel by the foot brake device even if the brake pedal is released by the driver after a shift lever is moved to a parking position and before the braking force is applied to the wheels by the electric parking brake, if an inclination angle of a road surface is equal to or greater than a predetermined angle.

According to the teachings of JP-B-3454009, the control apparatus described in JP-B-3454009 reduces the operating force of the shift lever required to release the parking lock mechanism by generating torque by the motor until the parking pawl is disengaged from the parking lock gear. In addition, the output torque of the motor is reduced when it is determined that the parking lock mechanism is released. That is, the motor fully receives a torsional torque of the drive shaft, and lowers the torque of the motor when it is determined that the parking lock mechanism is released.

According to the teachings of JP-B-3454009, therefore, it takes time to determine that the parking locking mechanism is released. For this reason, if the braking torque applied to the wheels is reduced immediately after the parking lock mechanism is released, the vehicle may move unintentionally.

In addition, in the situation where the output torque of the motor is less than a magnitude possible to disengage the parking pawl from the parking lock gear, the torsional torque of the drive shaft propagates to the motor and a torque transmission member between the motor and a drive shaft when the parking lock mechanism is released. In this situation, the torsional torque is damped according to an elastic modulus of the drive shaft while pulsating. Therefore, if the determination that the parking lock mechanism has been released is delayed, the torque of the motor is added to the reversed torsional torque. As a result, the torsional torque of the drive shaft may not be damped promptly.

### SUMMARY

The embodiment of the present disclosure has been conceived noting the foregoing technical problems, and it is therefore an object of the present disclosure to provide a control system for a vehicle configured to suppress vibrations and shocks when releasing a parking lock mechanism in a situation where a drive shaft is twisted.

A control system according to the exemplary embodiment of the present disclosure is applied to a vehicle, comprising: a drive shaft in which one end thereof is joined to a wheel; a motor that applies a torque to the drive shaft; and a parking lock mechanism that stops a rotation of a predetermined rotary member arranged between the motor and the drive shaft by locking the rotary member, and that allows the rotary member to rotate by releasing the rotary member. In order to achieve the above-explained objective, according to the exemplary embodiment of the present disclosure, the control system is provided with a controller that controls the motor, comprising: a parking determiner configured to determine that the rotary member is locked by the parking lock mechanism; a predictor configured to predict that the rotary member being locked by the parking lock mechanism will be released by the parking lock mechanism; a torsional torque estimator configured to estimate a torsional torque acting on the drive shaft; a motor control starter configured to control the motor to start generation of a torque counteracting the estimated torsional torque whose magnitude is equal to the estimated torsional torque or smaller, when the predictor predicts that the rotary member being locked by the parking lock mechanism will be released by the parking lock mechanism; and a motor control terminator configured to terminate the torque generation by the motor when the motor generating the torque starts rotating.

In a non-limiting embodiment, the motor control terminator may be further configured to terminate the torque generation by the motor when a predetermined period of time has elapsed from a point at which the motor started the torque generation.

In a non-limiting embodiment, the motor control terminator may be further configured to terminate the torque generation by the motor when the rotary member being locked by the parking lock mechanism is released by the parking lock mechanism.

In a non-limiting embodiment, the control system may further comprise a shifting device that is operated by a driver to select an operating mode from a plurality of modes including a parking mode in which the rotary member is locked by the parking lock mechanism. In addition, the predictor may be further configured to predict that the rotary member being locked by the parking lock mechanism will be released by the parking lock mechanism, when a shifting operation is executed to shift the operating mode from the parking mode to another mode in which the rotary member is released by the parking lock mechanism.

In a non-limiting embodiment, the torsional torque estimator may be further configured to estimate the torsional torque acting on the drive shaft based on an inclination angle of the vehicle in a pitching direction.

Thus, according to the exemplary embodiment of the present disclosure, the motor starts generating the torque counteracting the estimated torsional torque acting on the drive shaft whose magnitude is equal to the estimated torsional torque or smaller, when the rotary member being locked by the parking lock mechanism is expected to be released by the parking lock mechanism. That is, the motor starts generating the torque counteracting the torsional torque before the rotary member is released by the parking lock mechanism. According to the exemplary embodiment of the present disclosure, therefore, a load acting on the parking lock mechanism may be reduced, and the torque counteracting the torsional torque will not be changed abruptly when releasing the rotary member by the parking lock mechanism. For this reason, the torque delivered from the drive shaft to the motor may be reduced when releasing the rotary member by the parking lock mechanism. That is, a chang in a rotational speed of a torque transmission member between the motor and the drive shaft may be suppressed thereby reducing vibrations of the vehicle.

In addition, the torque generation by the motor is terminated when the motor starts rotating. According to the exemplary embodiment of the present disclosure, therefore, the torque of the motor may be reduced before the torsional torque is reversed. In other words, it is not necessary to determine that the rotary member being locked by the parking lock mechanism is released. For this reason, the torque of the motor may be reduced rapidly thereby suppressing an increase in the vibrations resulting from adding the output torque of the motor to the torsional torque. In other words, the vibration of the torque transmission members including the motor may be effectively damped after releasing the rotary member by the parking lock mechanism. For this reason, the vibrations of the vehicle Ve may be reduced promptly.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the control system according to the exemplary embodiment of the present disclosure is applied;

FIG. 2 is a block diagram showing functions of the controller;

FIG. 3 is a flow chart showing one example of a routine for determine whether to generate an assist torque by the motor;

FIG. 4 is a time chart showing changes in an operating mode, a shift position, an inclination angle of the vehicle, a motor control execution flag, an assist execution counter, and an absolute value of a rotational speed of the motor in a situation where the rotational speed of the motor is raised to a predetermined level so that the motor control execution flag is turned off;

FIG. 5 is a time chart showing changes in an operating mode, an inclination angle of the vehicle, a shift position, a rotational speed of the motor, and the motor control execution flag, in a situation where an operating mode other than the parking mode is selected so that the motor control execution flag is turned off; and

FIG. 6 is a time chart showing changes in an operating mode, an inclination angle of the vehicle, the motor control execution flag, a rotational speed of the motor, and the assist execution counter, in a situation where a count value of the assist execution counter is equal to or greater than a predetermined value so that the motor control execution flag is turned off.

### DETAILED DESCRIPTION OF THE EMBODIMENTS

An embodiment of the present disclosure will now be explained with reference to the accompanying drawings. Note that the embodiments shown below are merely examples of the present disclosure, and do not limit the present disclosure.

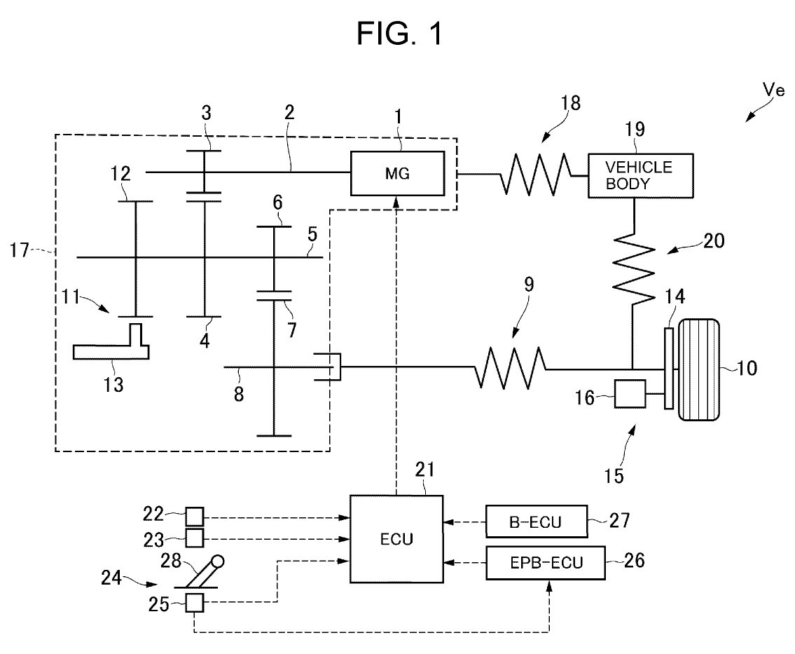

Referring now to FIG. 1, there is shown one example of a structure of a vehicle Ve to which the control system according to the exemplary embodiment of the present disclosure is applied. The vehicle Ve shown in FIG. 1 is an electric vehicle comprising a motor (referred to as MG in FIG. 1) 1 as a prime mover. As the motor 1, a motor serving as a prime mover of conventional electric vehicles and hybrid vehicles may be employed. The motor 1 is operated as a motor to generate a driving torque by supplying electric power thereto from a power storage device (not shown), and as a generator to translate a kinetic power of an output shaft 2 thereof into electric power at least partially by rotating the output shaft 2 passively. For example, a permanent magnet synchronous motor or an induction motor may be adopted as the motor 1.

A first drive gear 3 is mounted on the output shaft 2 of the motor 1, and a first driven gear 4 is mounted on an intermediate portion of the intermediate shaft 5 extending parallel to the output shaft 2 of the motor 1 to be meshed with the first drive gear 3. The first driven gear 4 is diametrically larger than the first drive gear 3 so that the first drive gear 3 and the first driven gear 4 serve as a reduction gear pair.

A second drive gear 6 is mounted on one end of the intermediate shaft 5, and a second driven gear 7 is mounted on an output shaft 8 extending parallel to the output shaft 2 and the intermediate shaft 5 to be meshed with the second drive gear 6. The second driven gear 7 is diametrically larger than the second drive gear 6 so that the second drive gear 6 and the second driven gear 7 also serve as a reduction gear pair. One end of the drive shaft 9 is joined to the output shaft 8 to rotate integrally therewith, and a wheel 10 is joined to the other end of the drive shaft 9.

The vehicle Ve is provided with a parking lock mechanism 11 that stops the rotation of the intermediate shaft 5 by locking the intermediate shaft 5, and allows the intermediate shaft 5 to rotate by releasing the intermediate shaft 5. A structure of the parking lock mechanism 11 is similar to those of parking lock mechanisms employed in the conventional vehicles. Specifically, the parking lock mechanism 11 comprises a parking lock gear 12 mounted on the other end of the intermediate shaft 5, a parking pawl 13 selectively engaged with the parking lock gear 12, and an actuator (not shown) for rotating the parking pawl 13. When a shift lever 28 of an after-mentioned shifting device 24 is moved to a parking position, the parking pawl 13 is rotated by the actuator to be meshed with the parking lock gear 12 thereby stopping a rotation of the parking lock gear 12. As a result, the rotation of the drive shaft 9 connected to the parking lock gear 12 through the intermediate shaft 5 in a torque transmittable manner is stopped.

A braking torque is applied to the wheel 10 by a brake device 14 according to a depression of a brake pedal (not shown) operated by a driver. As the brake device 14, brake devices arranged in the conventional vehicles may be employed. For example, a disk brake that applies a braking torque to the wheel 10 by clamping a brake rotor rotating integrally with the wheel 10 by a brake pad, and a drum brake that applies a braking torque to the wheel 10 by pressing a brake shoe from inside of a drum rotating integrally with the wheel 10 may be adopted as the brake device 14. A clamping force of the brake pad and a pushing force of the brake shoe may be controlled by an actuator (not shown) that generates a hydraulic pressure or an electromagnetic force in accordance with a depression of the brake pedal.

The vehicle Ve further comprises an electric parking brake (hereinafter, referred to as EPB) 15. When the shift lever 28 of the shifting device 24 is moved to the parking position, a motor 16 is activated to actuate a caliper or a brake shoe (neither of which are shown) of the EPB 15 to apply a braking torque to the wheel 10. Whereas, when the shift lever 28 of the shifting device 24 is moved to a position other than the parking position, the EPB 15 reduces the braking torque applied to the wheel 10. In order to fit the motor 16 easily into the vehicle Ve, the motor 16 may be arranged in a vehicle body, and the motor 16 and the caliper or the brake shoe may be connected to each other through a wire. In this case, the caliper and the brake shoe are actuated by rotating the motor 16 to wind up the wire.

In the vehicle Ve, the motor 1, a gear train for delivering a torque from the motor 1 to the output shaft 8, and a torque transmission member for delivering a torque from the motor 1 to the drive shaft 9 such as the output shaft 8 are held in a case 17, and the case 17 is connected to a vehicle body 19 through a mount 18. The wheel 10 is connected to the vehicle body 19 through a suspension 20.

An operating mode of the vehicle Ve is allowed to be shifted to a parking mode by moving the shift lever 28 to the parking position while depressing the brake pedal. In the parking mode, a rotation of the intermediate shaft 5 is stopped by the parking lock mechanism 11, and a braking torque is applied to the wheel 10 by the EPB 15.

When the above-mentioned shifting operation is executed by the driver to shift the operating mode to the parking mode, the rotation of the intermediate shaft 5 is stopped by the parking lock mechanism 11 before the braking torque is applied to the wheel 10 by the EPB 15. In this situation, given that the vehicle Ve is parked on a slope or that the vehicle Ve is parked such that some of the wheels 10 is/are stopped on a curb, the vehicle Ve is inclined in the pitching direction. In this case, if the driver returns the brake pedal before the braking torque is applied to the wheel 10 by the EPB 15, the wheel 10 will rotate even though the rotation of an input section of the drive shaft 9 is stopped. In addition, if the EPB 15 cannot function properly for some reason, the wheel 10 will also rotate after returning the brake pedal even though the rotation of the input section of the drive shaft 9 is stopped. As a result, the drive shaft 9 is twisted. That is, the drive shaft 9 is subjected to a torque (i.e., a torsional torque) in accordance with an elastic modulus and a torsion angle thereof.

In the above-described situations, the torsion angle (that is, the torsional torque) of the drive shaft 9 varies in accordance with an inclination angle of the vehicle Ve. Specifically, a load acting on the vehicle Ve in the longitudinal direction according to the inclination angle of the vehicle Ve is applied to a contact surface of the wheel 10 with a road surface, and such load and a torque according to a radius of the wheel 10 act on one end of the drive shaft 9. Whereas, the other end of the drive shaft 9 is locked by the parking lock mechanism 11 to prevent a rotation thereof. Therefore, the drive shaft 9 is gradually twisted and subjected to a torsional torque according to a torsion angle and the elastic modulus thereof. Eventually, when the torque applied to the drive shaft 9 from the wheel 10 and the torsional torque acting on the drive shaft 9 according to the torsion angle are balanced with each other, an increase in the torsion angle of the drive shaft 9 stops. Specifically, the drive shaft 9 is twisted in a direction corresponding to a direction of inclination of the vehicle Ve.

If the operating mode is shifted to a mode other than the parking mode in the situation where the drive shaft 9 is twisted, the torsion of the drive shaft 9 is eliminated when the intermediate shaft 5 locked by the parking lock mechanism 11 is released. When the torsion of the drive shaft 9 is eliminated, the torque is pulsated in accordance with the elastic modulus of the drive shaft 9. Specifically, after the torsion angle of the drive shaft 9 decreases toward zero, the drive shaft 9 is twisted in the inverse direction, and thereafter, the torsion angle of the drive shaft 9 decreases again toward zero. Thus, the torsion angle (peak value) of the drive shaft 9 decreases gradually while reversing a torsional direction thereof. Consequently, the case 17 is vibrated, and the vibrations propagate to the vehicle body 19 through the mount 18 while being damped. As a result, the vehicle Ve is vibrated.

In the situation where the drive shaft 9 is twisted, such vibrations of the vehicle Ve may be suppressed by generating an assist torque by the motor 1 to counteract the torsional torque acting on the drive shaft 9, when the intermediate shaft 5 is released by the parking lock mechanism 11.

However, the vehicle Ve is not provided with a sensor for detecting the torsional torque of the drive shaft 9. Therefore, the motor 1 may not be allowed to generate the assist torque exactly corresponding to the torsional torque of the drive shaft 9. For example, if the motor 1 generates the assist torque greater than the torsional torque of the drive shaft 9, the torsion angle of the drive shaft 9 is increased. In this case, it will take longer time to reduce the assist torque of the motor 1. In addition, vibration may be generated when reducing the torque of the motor 1 to eliminate the torsional torque.

For the reasons described above, the assist torque generated by the motor 1 is controlled to be equal to or less than an estimated torsional torque acting on the drive shaft 9. Specifically, when releasing the parking lock mechanism 11, the rotary member including the motor 1 connected to the drive shaft 9 is rotated by the torsional torque, and consequently the vehicle Ve is vibrated. A rotational speed (or a rotational angle) of the rotary member is varied by the pulsation of the torsional torque of the drive shaft 9. Therefore, in order to suppress the vibrations resulting from releasing the parking lock mechanism 11, the motor 1 generates the assist torque counteracting the torsional torque acting on the drive shaft 9 when the parking lock mechanism 11 is released and the torsional torque is reversed. In this situation, if the motor 1 generates the assist torque continuously, the rotational speed (or the rotational angle) of the rotary member may be increased by the assist torque. As a result, the torsional torque may not be damped promptly.

Therefore, the control system according to the exemplary embodiment of the present disclosure is configured to damp the torsional torque promptly by reducing the assist torque generated by the motor 1 at an appropriate timing. To this end, the control system is provided with an electronic control unit (hereinafter referred to as a ECU) 21 as a controller for controlling the motor 1. The ECU21 comprises a microcomputer configured to control an output torque of the motor 1 on the basis of incident signals using calculation expressions stored in advance.

The ECU 21 is connected with an acceleration sensor 22 that detects a longitudinal acceleration of the vehicle Ve, a resolver 23 that detects a rotational speed (or a rotational angle) of the motor 1, and a shift sensor 25 that detects the operating mode selected by the shifting device 24, so that signals are transmitted to the ECU 21 from the sensors 22, 23, and 25. In addition, an EPB-ECU 26 for controlling the EPB 15 and a B-ECU 27 for controlling the brake device 14 are also connected with the ECU 21 so that signals are also transmitted to the ECU 21 from the EPB-ECU 26 and the B-ECU 27.

For example, a so-called momentary shifting device may be adopted as the shifting device 24. In this case, when the shift lever 28 is moved from the initial position to a desired position, a signal corresponding to the position of the shift lever 28 is transmitted to the ECU 21 from the shift sensor 25, and when the shift lever 28 is released, the shift lever 28 returns to the initial position. As an option, the shifting device 24 may be provided with a parking button for selecting a parking mode, and the shift sensor 25 may be activated by pressing the parking button.

The EPB-ECU 26 is connected with the shift sensor 25. Specifically, the EPB-ECU 26 is configured to determine whether the EPB 15 is activated based on a signal transmitted from the shift sensor 25, and to transmit a command signal to the ECU 21 or the motor 16 based on a determination result. For example, a signal representing a depression of the brake pedal, a signal representing a pedal force applied to the brake pedal, and a signal representing a pressure of a master cylinder are transmitted to the B-ECU27. Otherwise, a detection signal of a hydraulic pressure or an electromagnetic force for generating a braking torque by the brake device 14 is transmitted to the B-ECU27. Specifically, the B-ECU27 is configured to calculate a braking torque to be generated by the brake device 14 based on the incident signals, and to transmit a command signal to the ECU 21 based on the calculated braking torque.

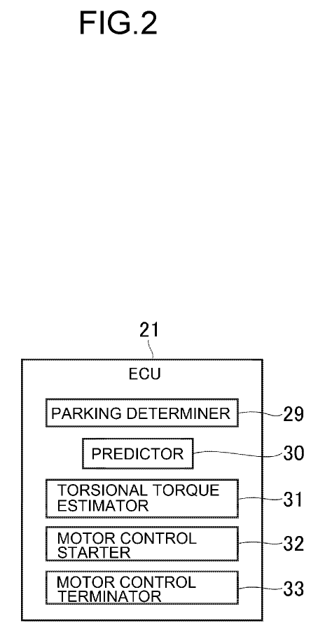

Turning to FIG. 2, there are shown functions of the ECU 21. As shown in FIG. 2, the ECU 21 comprises a parking determiner 29, a predictor 30, a torsional torque estimator 31, a motor control starter 32, and a motor control terminator 33.

The parking determiner 29 is configured to determine whether the vehicle Ve is in the parking mode in which the rotation of the intermediate shaft 5 is stopped by the parking lock mechanism 11. In other words, the parking determiner 29 is configured to determine whether the intermediate shaft 5 is locked by the parking lock mechanism 11. Specifically, the parking determiner 29 determines that the vehicle Ve is in the parking mode based on a fact that a predetermined time has elapsed since the shift lever 28 was moved to the parking position, or a fact that a command signal for actuating the parking pawl 13 is transmitted to the actuator.

The predictor 30 is configured to predict that the operating mode will be shifted from the parking range to another mode. Specifically, given that the momentary shifting device is adopted as the shifting device 24, the predictor 30 predicts that the operating mode will be shifted when the shift lever 28 is operated so that the shift sensor 25 is turned on. Instead, a conventional gate-type shifting device may also be adopted as the shifting device 24. Specifically, the gate-type shifting device is adapted to shift the operating mode to a mode corresponding to a shift position by moving the shift lever to a desired shift position within a shift gate. In a case where the gate-type shifting device is employed as the shifting device 24, the predictor 30 predicts that the operating mode is shifted from the parking mode to another mode when a shift button is turned on by moving the shift lever from the parking position.

The torsional torque estimator 31 is configured to estimate a torsional torque acting on the drive shaft 9. As described above, when the vehicle Ve is inclined in the pitching direction, the drive shaft 9 is twisted by the rotation of the wheels 10, and the drive shaft 9 is subjected to the torsional torque in accordance with the torsion angle and the elastic modulus thereof. Therefore, the torsional torque acting on the drive shaft 9 may be estimated based on e.g., an inclination angle of the vehicle Ve detected by the acceleration sensor 22.

The motor control starter 32 is configured to control the motor 1 so as to start generation of the assist torque against the torsional torque estimated by the torsional torque estimator 31 when the predictor 30 predicts that the operating mode will be shifted from the parking mode to another mode. That is, the motor control starter 32 controls the motor 1 to start torque generation based on a signal transmitted from the shift sensor 25.

In order to prevent the motor 1 from generating torque continuously, the motor control terminator 33 is configured to terminate the torque generation of the motor 1 when the motor 1 generating the assist torque starts rotating. Specifically, the motor control terminator 33 terminates the generation of the assist torque by the motor 1 when the rotational speed of the motor 1 increases to a predetermined speed or higher, or when the motor 1 rotates by a predetermined angle or greater, based on a detection value of the resolver 23. This is because the parking lock mechanism 11 is estimated to be released when the motor 1 rotates.

When the assist torque generated by the motor 1 and the torsional torque of the drive shaft 9 are balanced with each other, the motor 1 may not rotate even if the parking lock mechanism 11 is released. Therefore, the motor control terminator 33 terminates the generation of the assist torque by the motor 1 when the operating mode is shifted completely to the mode other than the parking mode. In other words, the motor control terminator 33 terminates the generation of the assist torque by the motor 1 when the parking lock mechanism 11 is released.

In addition, a shifting demand of the operating mode is rejected even if a shifting operation for shifting the operating mode from the parking mode to another mode is executed, given that the brake pedal is not depressed or that the brake pedal is returned before the completion of the shifting operation of the operating mode. In those cases, the operating mode will not be shifted, and the parking lock mechanism 11 is maintained to be locked. In this situation, if the assist torque is generated continuously by the motor 1, the amount of power consumption will be increased. In addition, electronic components for controlling the motor 1 will be heated and thermally damaged. Therefore, the motor control terminator 33 terminates the generation of the assist torque by the motor 1 when a predetermined time has elapsed since the motor 1 started generating the assist torque.

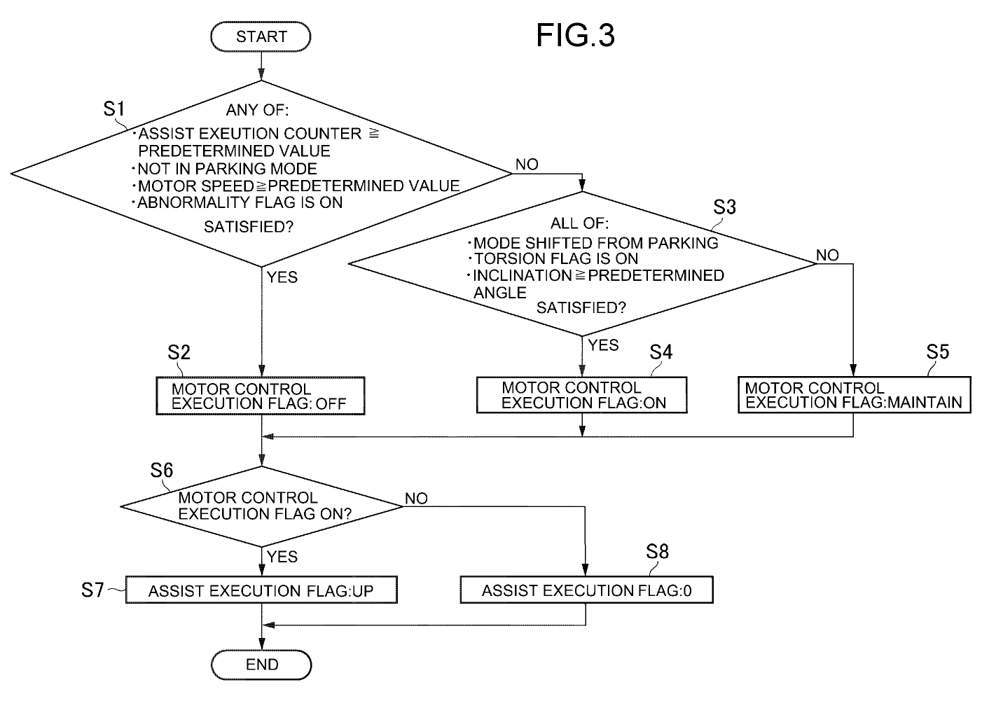

Turning to FIG. 3, there is shown one example of a routine executed by the ECU 21 to determine whether or not to generate the assist torque by the motor 1. At step S1, it is determined whether or not the condition to terminate the generation of the assist torque by the motor 1 is satisfied. Specifically, it is determined whether or not at least one of the below-mentioned conditions is satisfied. More specifically, it is determined whether or not the motor 1 is generating the assist torque continuously for a predetermined period of time or longer. To this end, the predetermined period is set taking into consideration an increase in a power consumption due to generation of the assist torque by the motor 1, and durability of electronic components for energizing the motor 1. Such determination at step S1 may be made based on whether or not a count value of the after-mentioned assist execution counter is equal to or greater than a predetermined value. For example, the predetermined value may be set based on a result of an experiment, to a value corresponding to a length of time longer than a length of time required to release the parking lock mechanism 11 from a point at which the parking lock mechanism 11 is demanded to be released.

In addition, at step S1, it is determined whether or not the drive shaft 9 is unlocked by the parking lock mechanism 11. In other words, it is determined whether or not an operating mode other than the parking mode is selected. Further, at step S1, it is determined whether or not the torsion of the drive shaft 9 has been eliminated. Specifically, it is determined whether or not an absolute value of a rotational speed (or rotational angle) of the motor 1 is equal to or greater than a predetermined speed (or predetermined angle). Furthermore, at step S1, it is determined whether or not some kind of failure that cannot appropriately control the torque acting on the drive shaft 9 has occurred while the motor 1 is generating the assist torque. In short, it is determined whether or not an abnormality flag is on. For example, the anomality flag is turned on in the event of a communication error between the ECU 21 and the EPB-ECU 26 or the B-ECU 27.

If at least one of the following conditions: that the count value of the assist execution counter is equal to or greater than the predetermined value; that the operating mode other than the parking mode is selected; that the absolute value of the rotational speed of the motor 1 is equal to or higher than the predetermined speed; and that the abnormality flag is on, is satisfied, the answer of step S1 will be YES. In this case, the routine progresses to step S2 to turn off a motor control execution flag for executing the control to generate the assist torque by the motor 1.

By contrast, if the count value of the assist execution counter is less than the predetermined value, the parking range is selected, the absolute value of the rotational speed of the motor 1 is less than the predetermined speed, and the anomaly flag is off, the answer of the step S1 will be NO. In this case, the routine progresses to step S3 to determine the satisfaction of all of the following conditions: that the shifting operation to select the operating mode other than the parking mode is executed; that a torsion flag is on; and that an inclination angle of the vehicle Ve in the pitching direction is equal to or greater than a predetermined angle. Specifically, the torsion flag is turned on when a condition to twist the drive shaft 9 is satisfied. For example, the torsion flag is turned on in a case that the wheel 10 is allowed to rotate even though the rotation of an input section of the drive shaft 9 is stopped in a situation where a braking torque is not applied sufficiently to the wheel 10 in the parking mode. For example, the predetermined angle employed at step S3 may be set to an inclination angle at which the wheel 10 rotates in the situation where the braking torque is not applied to the wheel 10.

If the shifting operation to select the operating mode other than the parking mode is executed, the torsion flag is on, and the inclination angle of the vehicle Ve in the pitching direction is equal to or greater than the predetermined angle so that the answer of step S3 is YES, the routine progresses to step S4 to turn on the motor control execution flag. As a result, the motor 1 generates the assist torque counteracting the torsional torque. Specifically, the motor 1 generates the assist torque whose magnitude is equal to or less than the torsional torque estimated based on the inclination angle of the vehicle Ve.

By contrast, if at least any one of the following conditions: that the shifting operation to select the operating mode other than the parking mode is executed; that the torsion flag is on; and that the inclination angle of the vehicle Ve in the pitching direction is equal to or greater than the predetermined angle, is not satisfied so that the answer of the step S3 is NO, the routine progresses to step S5 to maintain a status of the motor control execution flag in the previous routine.

Then, the routine further progresses to step S6 to determine whether or not the motor control execution flag is on. If the motor control execution flag is on so that the answer of step S6 is YES, the routine progresses to step S7 to increment the count value of the assist execution counter, and thereafter returns. By contrast, if the motor control execution flag is off so that the answer of step S6 is NO, the routine progresses to step S8 to reset the count value of the assist execution counter to zero, and thereafter returns.

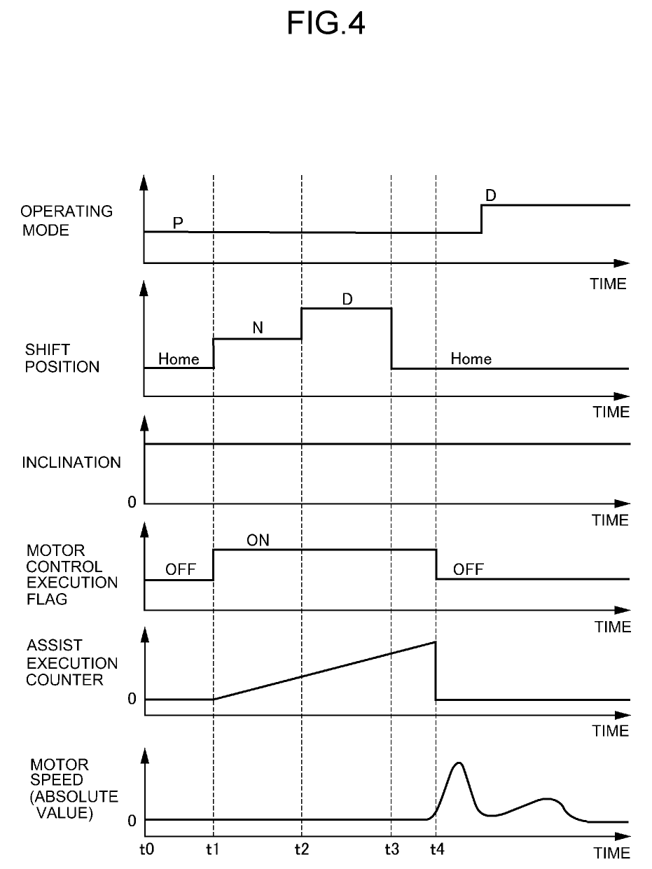

FIG. 4 shows changes in the operating mode, a shift position, an inclination angle of the vehicle Ve, a state of the motor control execution flag, a count value of the assist execution counter, and an absolute value of rotational speed of the motor 1 in the situation where the rotational speed of the motor 1 increases to the predetermined speed or higher so that the motor control execution flag is turned off. In the example shown in FIG. 4, the momentary shifting device is employed as the shifting device 24.

At point t0, the parking mode (P) is selected, and the inclination angle of the vehicle Ve is equal to or greater than the predetermined angle. Therefore, the torsion flag is on. However, since the shift lever 28 is positioned at the initial position (Home), the operating mode is not predicted to be shifted. In this situation, therefore, the motor control execution flag is off.

The shifting operation is commenced at point t1. Specifically, the shift lever 28 is moved from the initial position to the neutral position (N) at point t1, and further moved to the drive position at the point t2 to shift the operating mode from the parking mode to the drive mode (D). Then, at the point t3, the shift lever 28 is released from the driver's hand so that the shift lever 28 returns to the initial position.

When the shifting operation is commenced at point t1, it is predicted that the operating mode will be shifted from the parking mode to another mode. Therefore, the routine shown in FIG. 3 progresses from the step S3 to the step S4 at point t1. As a result, the motor control execution flag is turned on at point t1, and an increment of the count value of the assist execution counter is started from point t1. That is, the motor 1 starts generating the assist torque according to the inclination angle of the vehicle Ve. As described above, the magnitude of the assist torque is smaller than that of the torsional torque. In this situation, therefore, the parking lock gear 12 is brought into contact with the parking pawl 13 thereby stopping the rotation of the parking lock gear 12. Accordingly, the rotational speed of the motor 1 is not changed.

According to the example shown in FIG. 4, the parking lock mechanism 11 is released before point t4. Therefore, the load receiving the torsional torque of the drive shaft 9 attributed to the engagement between the parking lock gear 12 and the parking pawl 13 is reduced so that the excess torque calculated by subtracting the assist torque from the torsional torque is transmitted to the motor 1. Consequently, the motor 1 starts rotating immediately before the point t4. Eventually, at point t4, the rotational speed of the motor 1 is increased to the predetermined speed or higher, and hence the motor control execution flag is turned off. That is, the generation of the assist torque by the motor 1 is terminated. Thereafter, the operating mode is shifted to the drive mode.

Thus, the motor 1 starts generating the assist torque counteracting the torsional torque before releasing the parking lock mechanism 11. Therefore, a contact load between the parking lock gear 12 and the parking pawl 13 may be reduced. In other words, the torque counteracting the drive shaft 9 will not be changed abruptly when the parking lock mechanism 11 is released. Therefore, the torque transmitted from the drive shaft 9 to the motor 1 may be reduced when the parking lock mechanism 11 is released. For these reasons, a change in a rotational speed of the torque transmission member between the motor 1 and the drive shaft 9 may be suppressed so that the vibrations of the vehicle Ve may be suppressed.

In addition, the generation of the assist torque by the motor 1 is terminated when the rotational speed of the motor 1 increases to the predetermined speed or higher. That is, the generation of the assist torque by the motor 1 is terminated without determining that the parking lock mechanism 11 has been released. Therefore, the assist torque may be reduced before the torsional torque is reversed. Since the assist torque is not applied to the reversed torsional torque, the vibration of the vehicle Ve is not amplified by the assist torque. In other words, the vibration of the torque transmission members including the motor 1 may be effectively damped after the parking lock mechanism 11 is released. For this reason, the vibrations of the vehicle Ve may be reduced promptly.

When the parking lock mechanism 11 is released in a situation where the motor 1 is generating the assist torque, the rotational speed of the motor 1 is changed. Therefore, it is possible to determine that the parking lock mechanism 11 is released based on the rotational speed of the motor 1. However, for example, if the magnitude of the assist torque of the motor 1 matches the magnitude of the torsional torque of the drive shaft 9, the rotational speed of the motor 1 may not be changed even if the parking lock mechanism 11 is released. In this case, if the motor 1 generates torque continuously, the vibration may be amplified by applying the assist torque of the motor 1 to the torsional torque when the torsional torque of the drive shaft 9 is reversed. In addition, a power consumption is increased by continuously supplying electric power to the motor 1, and the electronic components supplying the electric power to the motor 1 may be damaged.

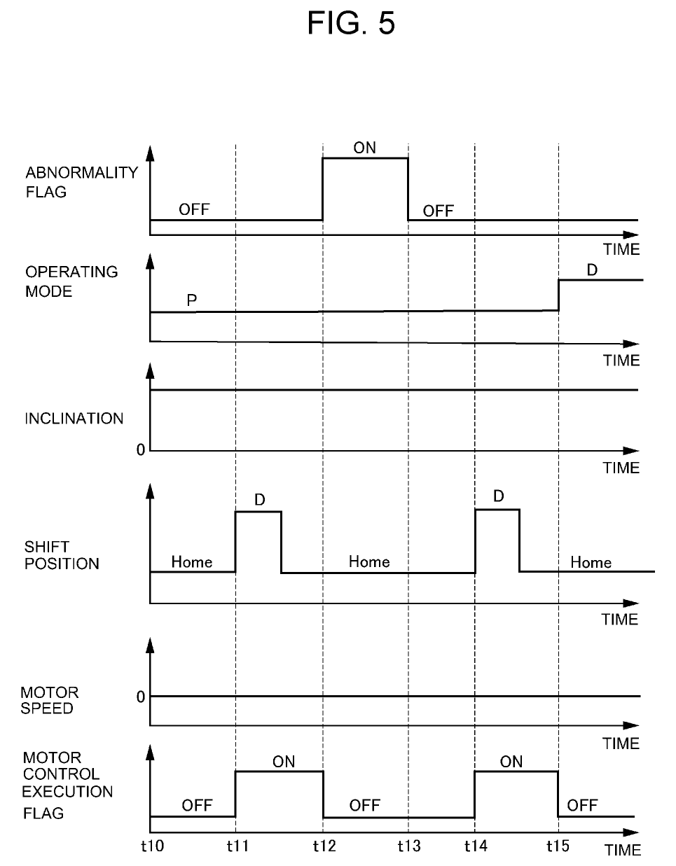

Therefore, the routine shown in FIG. 3 is configured to turn of the motor control execution flag when the operating mode other than the parking mode is selected. FIG. 5 shows changes in the operating mode, an inclination angle of the vehicle Ve, a shift position, a rotational speed of the motor 1, and a state of the motor control execution flag, in the situation where the operating mode other than the parking mode is selected so that the motor control execution flag is turned off. In addition, FIG. 5 also shows changes in a state of the abnormality flag, the operating mode, an inclination angle of the vehicle Ve, a shift position, a rotational speed of the motor 1, and a state of the motor control execution flag in the situation where the motor control execution flag is turned off based on the abnormality flag.

At point t10, the parking mode (P) is selected, and the inclination angle of the vehicle Ve is equal to or greater than the predetermined angle. Therefore, the torsion flag is on. However, since the shift lever 28 is positioned at the initial position (Home), the operating mode is not predicted to be shifted. In this situation, therefore, the motor control execution flag is off.

The shifting operation is commenced at point t11. Specifically, the shift lever 28 is moved from the parking position (P) to the drive position (D) so as to shift the operating mode from the parking mode to e.g., the drive mode. Consequently, it is predicted that the operating mode is shifted from the parking mode to another mode, and the motor control execution flag is turned on. In this situation, the motor 1 starts generating the assist torque according to the inclination angle of the vehicle Ve. As described above, the magnitude of the assist torque is smaller than that of the torsional torque. In this situation, therefore, the parking lock gear 12 is brought into contact with the parking pawl 13 thereby stopping the rotation of the parking lock gear 12. Accordingly, the rotational speed of the motor 1 is not changed.

At point t12, the abnormality determination flag is turned on for some reason so that the motor control execution flag is turned off. As a result, the generation of the assist torque by the motor 1 is terminated.

Thus, when an abnormality occurs and hence the torque acting on the drive shaft 9 may not be controlled properly, the motor control execution flag is turned off. Therefore, the drive shaft 9 will not be twisted, and vibrations and shocks will not be amplified by the assist torque when releasing the parking lock mechanism 11.

At point t13, the communication between ECU21 and EPB-ECU26 or B-ECU27 is back to normal by restarting the ECU 21, the EPB-ECU 26 or the B-ECU 27. Therefore, the anomaly flag is turned off at point t13.

Then, the shifting operation is commenced again at point t14. Specifically, the shift lever 28 is moved from the parking position (P) to another position (D). Consequently, it is predicted that the operating mode is shifted from the parking mode to another mode, and the motor control execution flag is turned on. In this situation, the motor 1 starts generating the assist torque according to the inclination angle of the vehicle Ve. As described above, the magnitude of the assist torque is smaller than that of the torsional torque. In this situation, therefore, the parking lock gear 12 is brought into contact with the parking pawl 13 thereby stopping the rotation of the parking lock gear 12. Accordingly, the rotational speed of the motor 1 is not changed.

Thereafter, at point t15, the parking lock mechanism 11 is released in the situation where the rotational speed of the motor 1 is not changed, and the operating mode is shifted from the parking mode to another mode so that the motor control execution flag is turned off.

As described above, in the case of shifting the operating mode from the parking mode to another mode, the parking lock mechanism 11 is released and hence vibrations or shocks will not be generated by the released torsional torque of the drive shaft 9. In this situation, since the assist torque is not generated unnecessarily by the motor 1, the vehicle Ve will not be moved unintentionally by such unnecessary assist torque. In addition, the vehicle Ve will not be vibrated. That is, in the case that the rotational speed of the motor 1 is not changed due to the coincidence of the torsional torque and the assist torque, the shifting of the operating mode is determined as an alternative means for stopping the generation of the assist torque. For this reason, the vehicle Ve may be prevented from moving unintentionally.

The vehicle Ve may be configured to allow the shifting operation of the operating mode from the parking mode to another mode only in the situation where the brake pedal is depressed. In this case, the brake pedal has to be depressed until the operating mode is shifted from the parking mode completely to another mode. Accordingly, the operating mode will not be shifted if the brake pedal is released before the operating mode is shifted from the parking mode by executing the shifting operation completely to another mode. That is, the parking lock mechanism 11 will not be released. Therefore, in a case that the operating mode is not shifted from the parking mode to another mode even if the shifting operation is executed so that the motor 1 starts generating the assist torque, the power consumption is increased if the generation of the assist torque by the motor 1 is continued. In addition, the electronic component for supplying the electric power to the motor 1 are heated and thermally damaged.

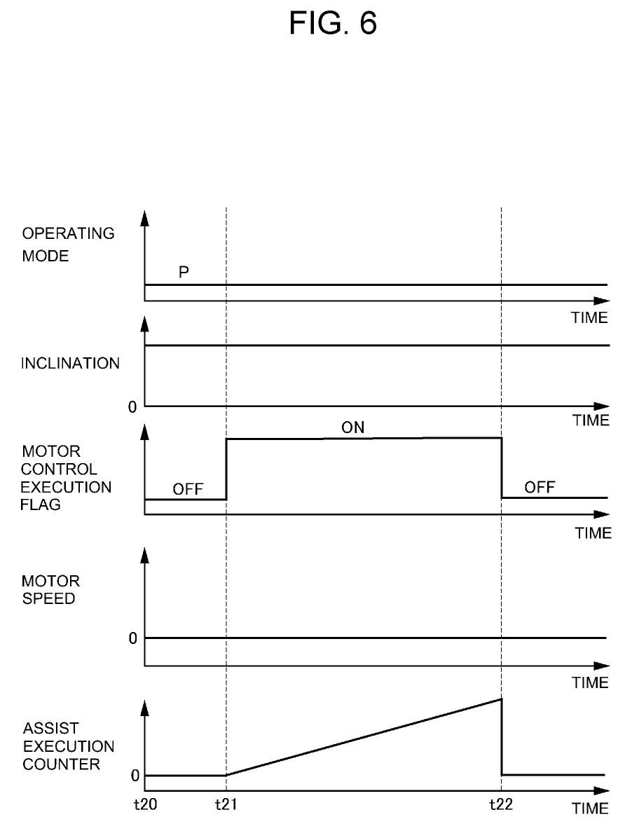

Therefore, according to the control example shown in FIG. 3, the motor control execution flag is turned off if the elapsed time after the motor control execution flag is turned on is equal to or greater than the predetermined time, more specifically, if the count value of the assist execution counter is equal to or greater than the predetermined value. FIG. 6 shows changes in the operating mode, the inclination angle of the vehicle Ve, a state of the motor control execution flag, a rotational speed of the motor 1, and a count value of the assist execution counter in the situation where the count value of the assist execution counter is equal to or greater than the predetermined value so that the motor control execution flag is turned off.

At point t20, the parking mode (P) is selected, and the inclination angle of the vehicle Ve is equal to or greater than the predetermined angle. Therefore, the torsion flag is on. However, since the shift lever 28 is positioned at the initial position (Home), the operating mode is not predicted to be shifted. In this situation, therefore, the motor control execution flag is off.

The shifting operation is commenced at point t21. Specifically, the shift lever 28 is moved from the parking position (P) to another position. Consequently, it is predicted that the operating mode is shifted from the parking mode to another mode, and the motor control execution flag is turned on. In this situation, the motor 1 starts generating the assist torque according to the inclination angle of the vehicle Ve. As described above, the magnitude of the assist torque is smaller than that of the torsional torque. In this situation, therefore, the parking lock gear 12 is brought into contact with the parking pawl 13 thereby stopping the rotation of the parking lock gear 12. Accordingly, the rotational speed of the motor 1 is not changed.

However, according to the example shown in FIG. 6, the parking lock mechanism 11 is not released even after the execution of the shifting operation. In other words, the operating mode is maintained to the parking mode. Therefore, the count value of the assist execution counter starts increasing from point t21, and reaches the predetermined value at point t22. As a result, the motor control execution flag is turned off. That is, the generation of the assist torque by the motor 1 is terminated.

As described above, when the count value of the assist execution counter increases to the predetermined value or greater, the parking lock mechanism 11 will not be released based on the shifting operation by which the generation of the assist torque by the motor 1 is determined. In this situation, since the generation of the assist torque by the motor 1 is terminated, the power consumption will not be increased. In addition, the electronic components connected to the motor 1 will not be heated so that the electronic components may be prevented from being thermally damaged. In other words, the assist execution counter serves as an alternative means for stopping the generation of the assist torque in the case that the parking lock mechanism 11 is not released.

Although the above examples of the present disclosure have been described, it will be understood by those skilled in the art that the present disclosure should not be limited to the described examples, and various changes and modifications can be made within the scope of the present disclosure. For example, the control system according to the exemplary embodiment of the present disclosure may also be applied to an electric vehicle in which torque is distributed from one motor to a pair of front wheels or rear wheels or to all wheels. In addition, the control system according to the exemplary embodiment of the present disclosure may also be applied to a hybrid-vehicle in which a prime mover includes a motor and an engine. Further, a configuration to join the drive shaft 9 to the motor 1, and the rotary member whose rotation is stopped by the parking lock mechanism 11 are not limited to those shown in FIG. 1. Furthermore, the EPB 15 may be omitted from the vehicle Ve.

What is claimed is:

1. A control system for a vehicle, comprising:
a drive shaft in which one end thereof is joined to a wheel;
a motor that applies a torque to the drive shaft; and
a parking lock mechanism that stops a rotation of a predetermined rotary member arranged between the motor and the drive shaft by locking the rotary member, and that allows the rotary member to rotate by releasing the rotary member;
the control system comprising:
a controller that controls the motor,
wherein the controller comprises:
a parking determiner configured to determine that the rotary member is locked by the parking lock mechanism;
a predictor configured to predict that the rotary member being locked by the parking lock mechanism will be released by the parking lock mechanism;
a torsional torque estimator configured to estimate a torsional torque acting on the drive shaft;
a motor control starter configured to control the motor to start generation of a torque counteracting the estimated torsional torque whose magnitude is equal to the estimated torsional torque or smaller, when the predictor predicts that the rotary member being locked by the parking lock mechanism will be released by the parking lock mechanism; and
a motor control terminator configured to terminate the torque generation by the motor when the motor generating the torque starts rotating.

2. The control system for the vehicle as claimed in claim 1, wherein the motor control terminator is further configured to terminate the torque generation by the motor when a predetermined period of time has elapsed from a point at which the motor started the torque generation.

3. The control system for the vehicle as claimed in claim 1, wherein the motor control terminator is further configured to terminate the torque generation by the motor when the rotary member being locked by the parking lock mechanism is released by the parking lock mechanism.

4. The control system for the vehicle as claimed in claim 1, further comprising:
a shifting device that is operated by a driver to select an operating mode from a plurality of modes including a parking mode in which the rotary member is locked by the parking lock mechanism,
wherein the predictor is further configured to predict that the rotary member being locked by the parking lock mechanism will be released by the parking lock mechanism, when a shifting operation is executed to shift the operating mode from the parking mode to another mode in which the rotary member is released by the parking lock mechanism.

5. The control system for the vehicle as claimed in claim 2, further comprising:
a shifting device that is operated by a driver to select an operating mode from a plurality of modes including a parking mode in which the rotary member is locked by the parking lock mechanism,
wherein the predictor is further configured to predict that the rotary member being locked by the parking lock mechanism will be released by the parking lock mechanism, when a shifting operation is executed to shift the operating mode from the parking mode to another mode in which the rotary member is released by the parking lock mechanism.

6. The control system for the vehicle as claimed in claim 3, further comprising:
a shifting device that is operated by a driver to select an operating mode from a plurality of modes including a parking mode in which the rotary member is locked by the parking lock mechanism,
wherein the predictor is further configured to predict that the rotary member being locked by the parking lock mechanism will be released by the parking lock mechanism, when a shifting operation is executed to shift the operating mode from the parking mode to another mode in which the rotary member is released by the parking lock mechanism.

7. The control system for the vehicle as claimed in claim 1, wherein the torsional torque estimator is further configured to estimate the torsional torque acting on the drive shaft based on an inclination angle of the vehicle in a pitching direction.

8. The control system for the vehicle as claimed in claim 2, wherein the torsional torque estimator is further configured to estimate the torsional torque acting on the drive shaft based on an inclination angle of the vehicle in a pitching direction.

9. The control system for the vehicle as claimed in claim 3, wherein the torsional torque estimator is further configured to estimate the torsional torque acting on the drive shaft based on an inclination angle of the vehicle in a pitching direction.
